(19) United States
(12) Patent Application Publication
(10) Pub. No.: US 2014/0002571 A1
(43) Pub. Date: Jan. 2, 2014

(54) IMAGE FORMING APPARATUS

(71) Applicant: Daisuke Aruga, Toride-shi (JP)

(72) Inventor: Daisuke Aruga, Toride-shi (JP)

(73) Assignee: CANON KABUSHIKI KAISHA, Tokyo (JP)

(21) Appl. No.: 14/004,459

(22) PCT Filed: Jul. 3, 2012
(86) PCT No.: PCT/JP2012/067416

§ 371 Date: Sep. 11, 2013

(30) Foreign Application Priority Data
Jul. 22, 2011 (JP) 2011-161087

(51) Int. Cl. B41J 2/435

(52) U.S. Cl. CPC G03G 21/1853
USPC 347/224

(57) ABSTRACT

In order to reduce a vibration of a stay to be transmitted to a light scanning apparatus, provided is an image forming apparatus including, a photosensitive drum 310, a light scanning apparatus 100 forming an electrostatic latent image on the photosensitive drum 310 based on image data, and a stay 40 attached to a main body of the image forming apparatus. The light scanning apparatus 100 is mounted on the stay 40 through multiple attaching portions 90a, 90b, and 90c. The stay 40 includes multiple supporting portions 43a, 43b, and 43c to which the multiple attaching portions 90a, 90b, and 90c are attached. Slits 44a, 44b, and 44c having a flexed shape or a curved shape are formed between the supporting portions 43a, 43b, and 43c and a central portion of the stay 40 so as to surround at least one of the supporting portions 43a, 43b, and 43c.

### TECHNICAL FIELD

The present invention relates to vibration of a light scanning apparatus provided in an image forming apparatus.

### BACKGROUND ART

Generally, in an image forming apparatus, a light scanning apparatus, a photosensitive drum, a developing device, and a fixing device are each attached to a supporting member, such as a stay, and the supporting member is attached to two side plates provided in the image forming apparatus. A vibration generated during motor driving or gear meshing in the photosensitive drum, the developing device, the fixing device or the like is finally transmitted to the light scanning apparatus through the side plates and the stay and. Then, the light scanning apparatus itself or each optical component provided in the light scanning apparatus is forcibly vibrated, and resonates when the frequency of the transmitted vibration is close to the natural frequency of the light scanning apparatus itself or each optical component provided in the light scanning apparatus. As a result, unevenness occurs at a laser irradiation position in a sub-scanning direction onto the photosensitive drum, and a band-like image defect called pitch unevenness occurs. Accordingly, there is a demand for a reduction in vibration to be transmitted to the light scanning apparatus.

As a countermeasure against the vibration, in an image forming apparatus of Patent Literature 1, for example, a pedestal is folded at four sides and a notch is provided at the center of each folded portion. Thus, the positions of an anti-node and a node of a vibration of a mode C of the pedestal are changed, and the vibration is replaced by a vibration of a mode C′. Accordingly, a supporting portion that supports a light scanning apparatus at the anti-node of the vibration is allowed to be closer to the node of the vibration, thereby reducing the vibration of the supporting portion and reducing the vibration to be transmitted to the light scanning apparatus.

### CITATION LIST

### Patent Literature

PTL 1: Japanese Patent Application Laid-Open No. 2001-183596

### SUMMARY OF INVENTION

### Technical Problem

In Patent Literature 1, however, a notch is provided at each folded portion of a pedestal, thereby achieving the reduction in the vibration of the mode C, but fails to reduce vibrations of other modes. Accordingly, there is a possibility that the light scanning apparatus is greatly displaced and visible pitch unevenness occurs when a vibration having a frequency that poses a problem of pitch unevenness is generated in the pedestal. Therefore, to reduce the pitch unevenness, it is necessary to reduce the vibration of the pedestal (stay) to be transmitted to the light scanning apparatus.

It is an object of the present invention to reduce a vibration of a stay to be transmitted to a light scanning apparatus.

### Solution to Problem

To solve the above-described problem, according to an exemplary embodiment of the present invention, there is provided an image forming apparatus including: an image bearing member; a latent image forming unit configured to form an electrostatic latent image on the image bearing member based on image data, and a mounting board which is attached to a main body of the image forming apparatus and on which the latent image forming unit is mounted, the mounting board including a plurality of supporting portions to which a plurality of attaching portions provided to the latent image forming unit is attached, and the mounting board including an opening which has one of a flexed shape or a curved shape and which is formed between the supporting portions and a central portion of the mounting board so as to surround at least one of the supporting portions.

According to the present invention, it is possible to reduce a vibration of a stay to be transmitted to a light scanning apparatus.

Further features of the present invention will become apparent from the following description of exemplary embodiments with reference to the attached drawings.

### BRIEF DESCRIPTION OF DRAWINGS

FIG. 1 illustrates an image forming apparatus of first to third embodiments.

FIG. 2A illustrates a light scanning apparatus attached to the image forming apparatus of the first to third embodiments.

FIG. 2B is a cross-sectional view taken along the line 2B-2B of FIG. 2A.

FIG. 3A illustrates the light scanning apparatus of the first to third embodiments.

FIG. 3B illustrates the light scanning apparatus of the first to third embodiments.

FIG. 4A illustrates a main scanning cross-sectional view and a sub-scanning cross-sectional view of the light scanning apparatus of the first to third embodiments.

FIG. 4B illustrates a main scanning cross-sectional view and a sub-scanning cross-sectional view of the light scanning apparatus of the first to third embodiments.

FIG. 5A illustrates a vibration transmission path and a vibration mode of a stay within the image forming apparatus (including a stay) of the first to third embodiments.

FIG. 5B illustrates a vibration transmission path and a vibration mode of a stay within the image forming apparatus (including a stay) of the first to third embodiments.

FIG. 6A illustrates a stay of the first embodiment.

FIG. 6B is a cross-sectional view taken along the line 6B-6B of FIG. 6A.

FIG. 7 illustrates a displacement analysis result during a first mode vibration of the stay of the first embodiment.

FIG. 8 illustrates a stay of the second and third embodiments.

FIG. 9 illustrates a displacement analysis result during the first mode vibration of the stay of the second embodiment.

FIG. 10 illustrates results of a first mode vibration test of the second and third embodiments.

### DESCRIPTION OF EMBODIMENTS

Modes for carrying out the present invention will be described in more detail below with reference to embodiments.

### First Embodiment

### Outline of Image Forming Apparatus

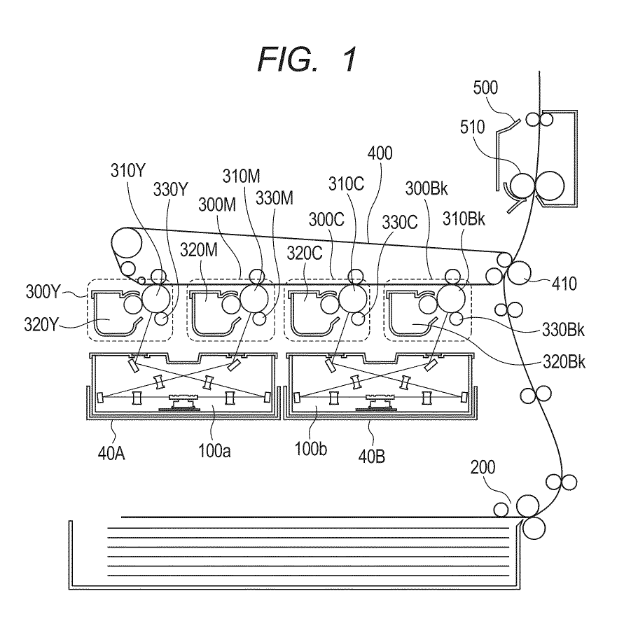

FIG. 1 is a schematic block diagram of an image forming apparatus of a first embodiment. The image forming apparatus illustrated in FIG. 1 includes four image forming engines 300Y, 300M, 300C, and 300Bk which respectively form yellow, magenta, cyan, and black toner images. Reference symbols Y, M, C, and Bk are omitted except when required to describe specific colors in the following. Each image forming engine 300 includes a photosensitive drum 310, a charging roller 330, and a developing device 320. The charging roller 330 charges the photosensitive drum 310 to a uniform potential. The developing device 320 forms a toner image on an electrostatic latent image which is formed on the photosensitive drum 310 (on an image bearing member) serving as a photosensitive member, by the exposure of laser output from a light scanning apparatus 100 (latent image forming unit). Each image forming engine 300 forms a toner image corresponding to image data of each color on the photosensitive drum 310. The image forming apparatus includes an intermediate transfer belt 400 onto which the toner image formed on the photosensitive drum 310 is primary transferred. The toner images multiply transferred onto the intermediate transfer belt 400 are secondarily transferred, by a transfer roller 410, onto a recording sheet transported from a sheet feed portion 200, with the result that a color image is formed on the recording sheet. The toner images secondarily transferred onto the recording sheet by the intermediate transfer belt 400 are transported to a fixing device 500. Further, the toner images are nipped by a fixing roller 510 and applied with heat and pressure, thereby being fixed onto the recording sheet.

The four image forming engines 300 are provided in parallel below the intermediate transfer belt 400. The light scanning apparatus 100 is provided below the image forming engine 300. The light scanning apparatus 100 exposes the photosensitive drum 310, which is included in the image forming engine 300, according to the image data. Further, the light scanning apparatus 100 includes two units that output two-channel scanning light. One unit (light scanning apparatus 100a) scans photosensitive drums 310Y and 310M, and the other unit (light scanning apparatus 100b) scans photosensitive drums 310C and 310Bk. The light scanning apparatus 100a is supported by a stay 40A (mounting board), and the light scanning apparatus 100b is supported by a stay 40B (mounting board). The detailed structure of each stay 40 will be described later.

### Light Scanning Apparatus Attached to Image Forming Apparatus

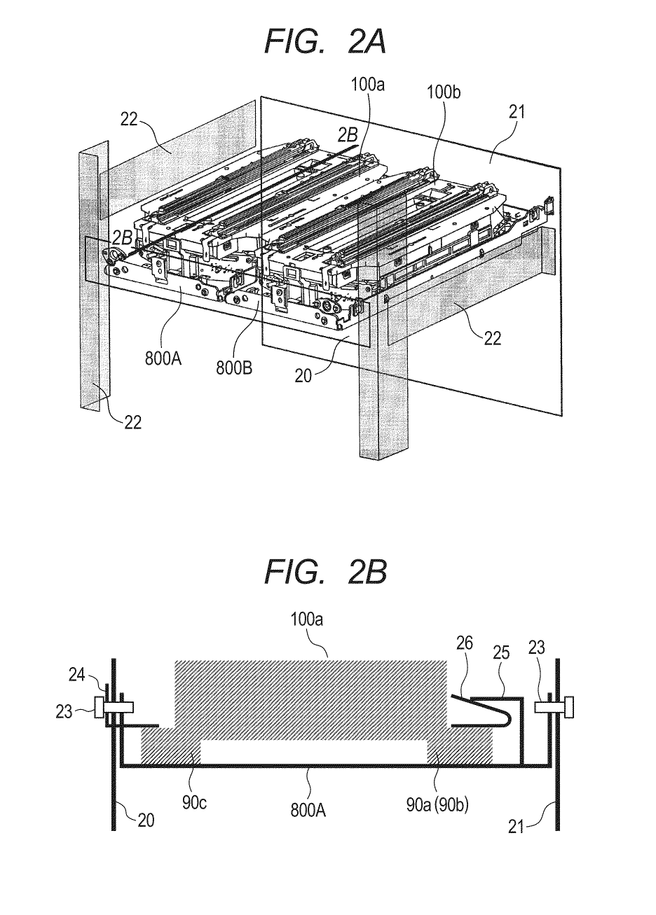

FIGS. 2A and 2B illustrate the structure of the image forming apparatus of this embodiment. In FIG. 2A, stays 800A and 800B on which the two light scanning apparatuses 100a and 100b are respectively mounted are attached to the image forming apparatus main body. Housings of the light scanning apparatuses 100a and 100b include multiple attaching portions 90a, 90b, and 90c (leg portions, projecting portions) that project to the outside of the housing from a bottom surface, and are respectively mounted on the stays 800A and 800B through the multiple attaching portions 90a, 90b, and 90c. The stays 800A and 800B illustrated in FIGS. 2A and 2B illustrate comparative examples of each stay 40 of this embodiment. Both side plates 20 and 21 are supported by multiple supporting members 22. The multiple supporting members 22 as well as the side plates 20 and 21 are integrally fixed and formed as a frame of the image forming apparatus. FIG. 2B is a cross-sectional view taken along the line 2B-2B of the image forming apparatus illustrated in FIG. 2A, and also illustrates the state where the light scanning apparatus 100a is attached onto the stay 800A. The stay 800A is attached to the side plates 20 and 21 of the image forming apparatus by multiple screws 23, and is positioned to bridge between the side plates 20 and 21.

On the side of the side plate 20 (on an apparatus front side), the attaching portion 90c is pressed against the stay 800A by a plate spring 24, which is attached to the side plate 20, thereby allowing the light scanning apparatus 100a to be fixed onto the stay 800A. On the other hand, on the side of the side plate 21 (on an apparatus back side), the attaching portions 90a and 90b are pressed against the stay 800A by a plate spring 26, which abuts against a spring bearing portion 25 provided on the stay 800A, thereby allowing the light scanning apparatus 100a to be fixed onto the stay 800A. Thus, the light scanning apparatus 100a is fixed onto the stay 800A by the plate springs 24 and 26. The position in the direction of gravitational force of the light scanning apparatus 100a is determined by the position where the stay 800A is attached to the image forming apparatus. The plate springs 24 and 26 are formed of stainless steel.

### Optical Path of Light Scanning Apparatus

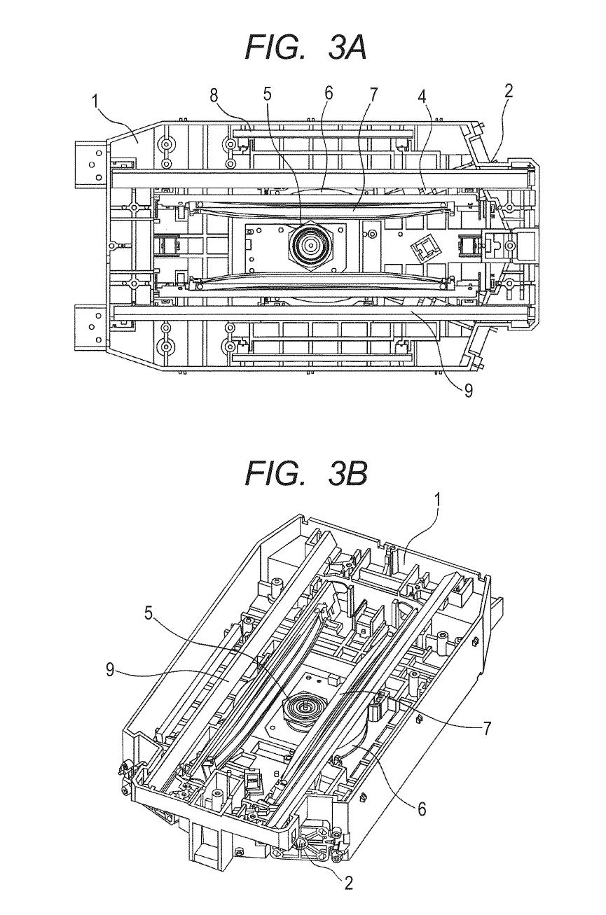

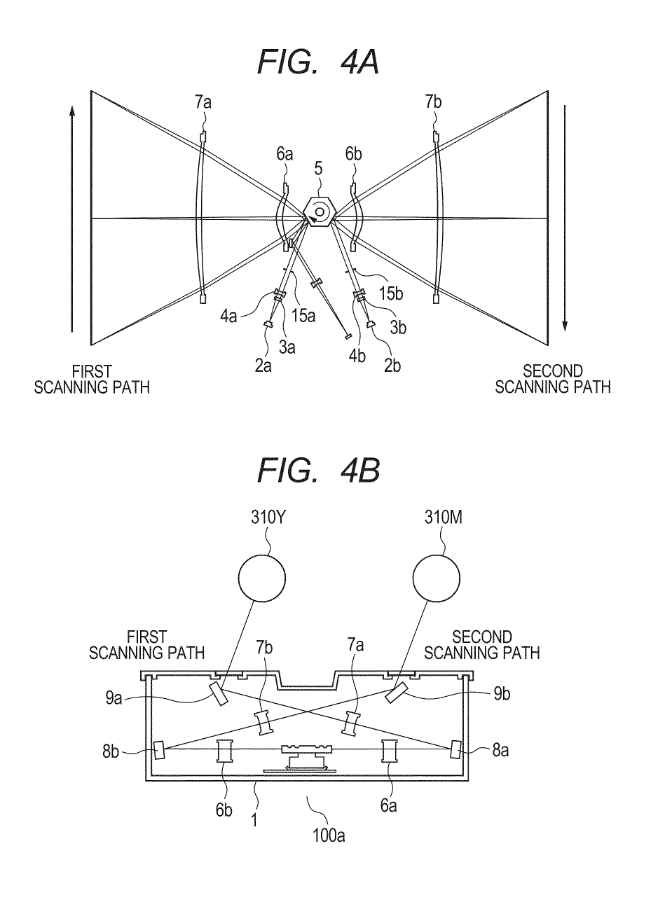

FIG. 3A illustrates a top view of the light scanning apparatus 100 of this embodiment, and FIG. 3B illustrates a perspective view thereof. FIG. 4A is a main scanning cross-sectional view in which the light scanning apparatus 100 illustrated in FIG. 3A is rotated rightward by 90 degrees and the optical path of the light scanning apparatus is developed into a plane. A polygon mirror 5 is a deflection unit that deflects laser so as to allow the laser (light beam) output from light sources 2a and 2b to scan the surface of the photosensitive drum. A direction in which the laser is allowed to scan by the rotation of the polygon mirror 5 is referred to as a main scanning direction, and a direction which is orthogonal to the main scanning direction and perpendicular to the rotation axis of the polygon mirror 5 is referred to as a sub-scanning direction. The term “main-scanning cross-section” refers to a plane which is parallel to the scanning direction and perpendicular to the rotation axis of the polygon mirror 5.

As illustrated in FIG. 4A, two scanning paths, that is, a first scanning path and a second scanning path, are symmetrically provided with the polygon mirror 5 interposed therebetween, and the first scanning path and the second scanning path scan the respective photosensitive drums 310. In the first scanning path, the laser output from the light source 2a is converted into parallel light by a collimator lens 3a, and the laser is converged only in the sub-scanning direction by a cylindrical lens 4a which is disposed immediately after the collimator lens 3a. Then, the laser converged only in the sub-scanning direction is shaped into a predetermined shape by a diaphragm 15a and is then formed into a linear image on a reflection surface of the polygon mirror 5. The laser formed into an image on the polygon mirror 5 is scanned by the rotation of the polygon mirror 5. Further, the surface of the photosensitive drum 310 is scanned at a uniform rate and an image is formed thereon by fθ lenses 6a and 7a. The structure in the second scanning path is the same as the above-described structure of the first scanning path, so the description thereof is omitted.

FIG. 4B is a sub-scanning cross-sectional view of the light scanning apparatus 100a which is mounted with the optical system described with reference to FIG. 4A. The term “sub-scanning cross-section” refers to a plane which is perpendicular to the scanning direction and parallel to the rotation axis of the polygon mirror 5. Though FIG. 4A illustrates that the optical system is developed into a plane, the light scanning apparatus 100a actually scans the photosensitive drums 310Y and 310M in a stereoscopic path by using the reflection mirror as illustrated in FIG. 4B. Specifically, in the light scanning apparatus 100a, a first mirror 8a is provided between the fθ lenses 6a and 7a on the laser optical path of the first scanning path, and a second mirror 9a is further provided after the laser passes through the fθ lens 7a, thereby guiding the laser by two reflections to the photosensitive drum 310Y. The second scanning path has the same structure as that of the first scanning path, so the description thereof is omitted. All of these optical components are accommodated in a housing 1 and constitute the light scanning apparatus 100a. The light scanning apparatus 100b has the same structure as that of the light scanning apparatus 100a, so the description thereof is omitted. Note that the fθ lenses 6a and 7a and the reflection mirrors 8a and 9a are optical members that guide the laser to the photosensitive drum 310Y, and are accommodated in the housing of the light scanning apparatus 100a together with the polygon mirror 5.

### Vibration Transmission in Image Forming Apparatus

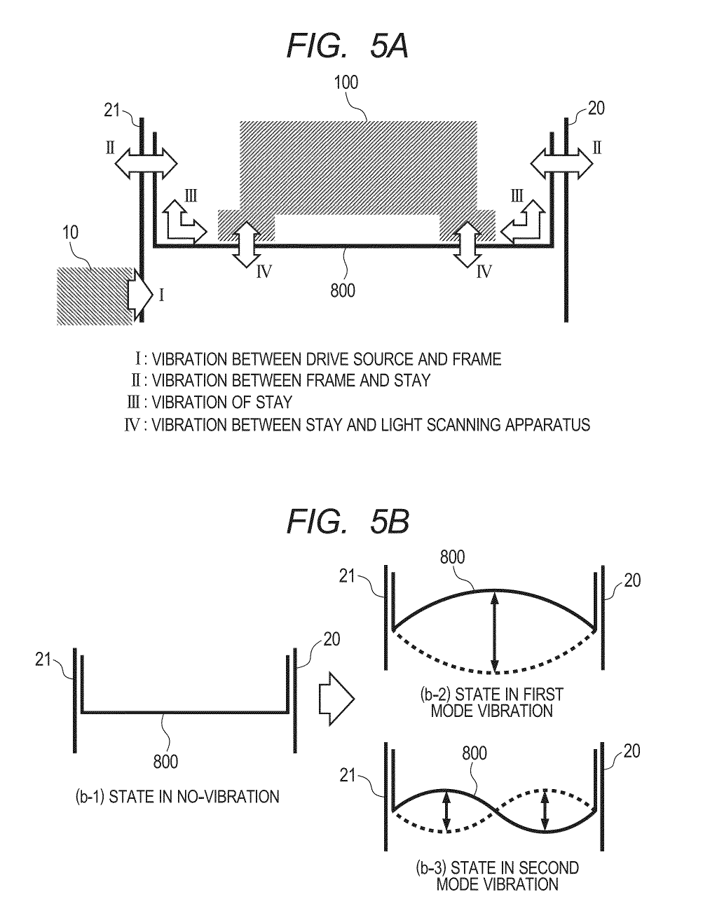

FIG. 5A illustrates a vibration to be transmitted in the image forming apparatus including the stay 800 illustrated in FIG. 2B. The screws 23, the plate spring 24, the spring bearing portion 25, and the plate spring 26 are omitted. The light scanning apparatus 100 is attached onto the stay 800, which is fixed between the side plates 20 and 21, so as to bear the weight of the light scanning apparatus 100. A vibration of a drive source 10 is generated in image forming engine 300, the fixing device 500, and the like illustrated in FIG. 1, due to a motor for rotationally driving the transfer roller 410 and the fixing roller 510 or gear meshing. The vibration generated in the drive source 10 is transmitted to the side plates 20 and 21 (I in FIG. 5A) and is further transmitted from the side plates 20 and 21 to the stay 800 (II in FIG. 5A). The vibration transmitted to the stay 800 is transferred within the stay 800 (III in FIG. 5A) and is transmitted from the stay 800 to the light scanning apparatus 100 (IV in FIG. 5A).

### Structure of Stay

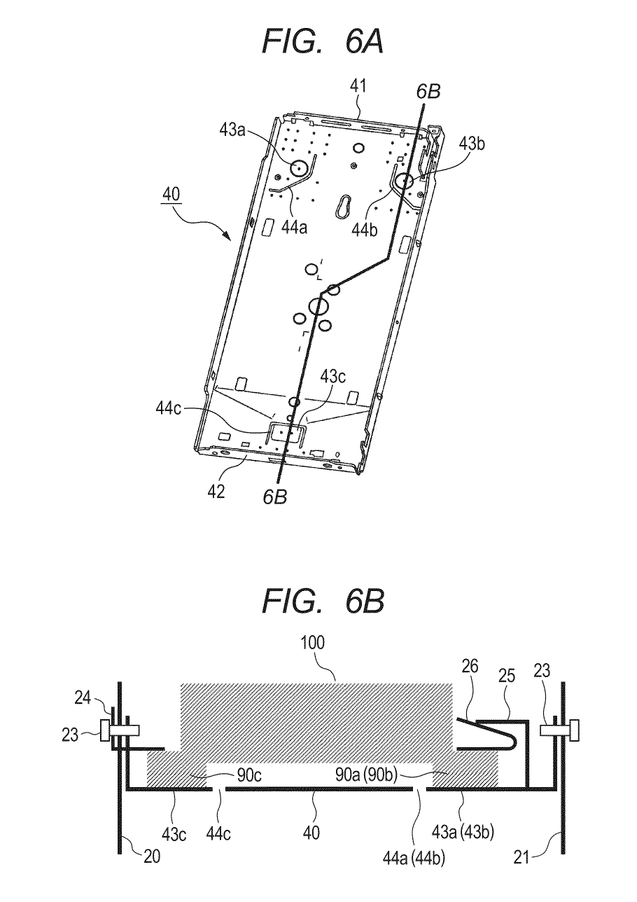

FIG. 6A illustrates the stay 40 of this embodiment.

The light scanning apparatus 100 of this embodiment has a structure in which the light scanning apparatus 100 is supported by the stay 40. The stay 40 is a rectangular plate material. The light scanning apparatus 100 may be installed in the image forming apparatus in such a manner that multiple beams are provided to the side plates 20 and 21 so as to respectively correspond to the multiple attaching portions 90a, 90b, and 90c of the light scanning apparatus 100 and the light scanning apparatus 100 is mounted on the beams. However, if there is a deviation in a relative positional relation between the multiple beams after the installation in the height direction of FIG. 2B, the light scanning apparatus 100 is installed in an inclined manner in the image forming apparatus, which makes it difficult to enhance the installation accuracy of the light scanning apparatus 100. On the other hand, the stay 40 is a plate-like member, and the flatness is ensured before the installation. Thus, the attaching portions 90a, 90b, and 90c of the light scanning apparatus 100 are supported by the stay 40, thereby enhancing the installation accuracy of the light scanning apparatus 100. In the case of providing multiple beams, it is necessary to attach the beams to the side plates 20 and 21, which complicates the installation process. Meanwhile, in the image forming apparatus of this embodiment, the supporting structure of the light scanning apparatus 100 can be formed merely by attaching the stay 40 to the side plates 20 and 21, which relatively facilitates the installation process.

The rectangular plate material is folded at four sides, thereby securing a sufficient rigidity of the stay 40 for supporting the light scanning apparatus 100. Folded portions 41 and 42 of the stay 40 which are opposed each other are provided with screw holes for the attachment to the side plates 20 and 21. The stay 40 is attached between the side plates 20 and 21 by the screws 23, like the stay 800 illustrated in FIG. 2B. FIG. 6B is a cross-sectional view of the stay 40 taken along the line 6B-6B of FIG. 6A. Supporting portions 43a, 43b, and 43c are provided at end portions of the stay 40. The supporting portions 43a, 43b, and 43c respectively support the attaching portions 90a, 90b, and 90c of the light scanning apparatus, and the attaching portions 90a, 90b, and 90c are fixed by the plate springs 24 and 26 on the supporting portions 43a, 43b, and 43c. Unlike the stay 800 illustrated in FIGS. 2A and 2B and FIGS. 5A and 5B, the stay 40 of this embodiment includes slits 44a, 44b, and 44c (openings) having different shapes around the supporting portions 43a, 43b, and 43c which are provided at end portions.

Each of the slits 44a and 44b has a curved shape, and the direction of the protrusion of the curved shape is directed to a central portion of the stay 40. The slits 44a and 44b are formed in the stay 40 so as to respectively surround the supporting portions 43a and 43b between the central portion of the stay 40 and the supporting portions 43a and 43b (along the attaching portions 90a and 90b of the light scanning apparatus 100 which are attached to the supporting portions 43a and 43b). The slit 44c has a flexed shape, and the direction of the protrusion of the flexed shape is directed to the central portion of the stay 40. The slit 44c is formed in the stay 40 so as to surround the supporting portion 43c between the central portion of the stay 40 and the supporting portion 43c (along the attaching portion 90c of the light scanning apparatus 100 which is attached to the supporting portion 43c). The slits 44a, 44b, and 44c are provided to reduce the vibration of each of the supporting portions 43a, 43b, and 43c during the vibration of the stay 40. When the positions of the slits 44a, 44b, and 44c are located at a short distance (at a side closer to the supporting portion) from the respective supporting portions 43a, 43b, and 43c, which are provided at end portions of the stay 40, rather than the vicinity of the central portion of the stay 40, the effect of reducing the vibration can be expected. In this embodiment, the three supporting portions 43a, 43b, and 43c are provided. However, the number of the supporting portions 43a, 43b, and 43c is determined by the accuracy of the attaching position and the degree of stability against the vibration, and thus is not limited by the structure of this embodiment. The shapes of the slits 44a, 44b, and 44c are not limited by the structure of this embodiment, but any shape may be employed as long as the shape can surround the supporting portions 43a, 43b, and 43c as illustrated in FIG. 6A. For example, the slit 44c having a flexed shape includes two flexed portions, but the number of the flexed portions may be one or three or more.

### Analysis of Displacement Amount during Vibration

(b-1) of FIG. 5B illustrates the state where the stay 800 is in a no-vibration state. (b-2) of FIG. 5B illustrates a vibration mode of a first mode vibration of the stay 800. (b-3) of FIG. 5B illustrates a vibration mode of a second mode vibration of the stay 800. As illustrated in (b-2) of FIG. 5B, the mount of displacement of the stay 800 caused by a vibration generally becomes maximum in the first mode vibration having a low frequency. For example, in the image forming apparatus of this embodiment, a frequency of 100 Hz to 200 Hz causes a problem of visible pitch unevenness. When the vibration having the frequency of 100 Hz to 200 Hz which is generated in the drive source 10 of FIG. 5A is close to the natural frequency of the first mode of the stay 800 and the vibration is transmitted to the stay 800 as illustrated in FIG. 5A, the vibration of the first mode as illustrated in Fig. (b-2) of 5B is generated in the stay 800. The vibration of the stay 800 in the first mode causes the light scanning apparatus 100 to greatly swing, and conspicuous pitch unevenness of 1 mm to 2 mm, for example, which can be visually observed, may occur.

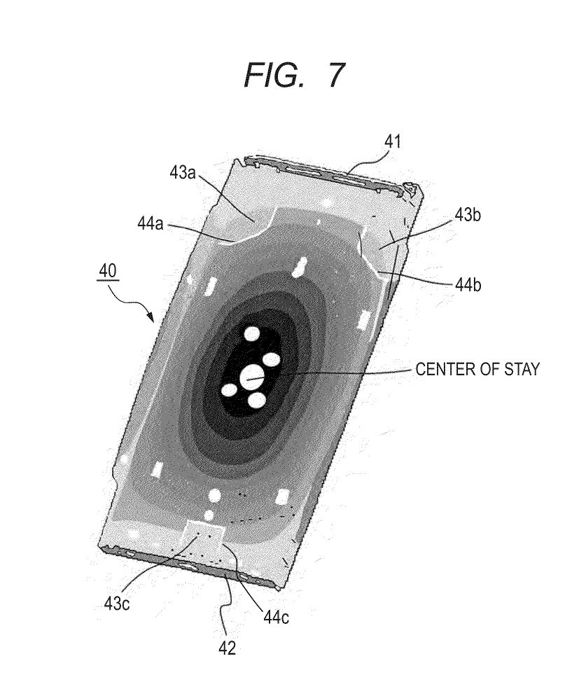

FIG. 7 illustrates an analysis result of the stay 40 of this embodiment which is displaced by the first mode vibration. As for the colors given to the stay 40 in FIG. 7, darker colors indicate a larger amount of displacement and paler colors indicate a smaller amount of displacement. Accordingly, it is apparent that the central portion (center) of the stay 40 represented by the darkest color shows the largest amount of displacement. It is also apparent that the amount of displacement of each of the supporting portions 43a, 43b, and 43c becomes locally smaller than the surrounding area. The amount of displacement in the portion represented by the palest color (the color of the supporting portion 43c) on the stay of FIG. 7 is negligibly small, and thus the vibration that causes a problem of pitch unevenness is not generated.

The slits 44a, 44b, and 44c function to separate the supporting portions 43a, 43b, and 43c from the central portion of the stay 40 having a maximum displacement amount during the first mode vibration. As a result, the amount of displacement of each of the supporting portions 43a, 43b, and 43c that are deformed to be pulled by the central portion of the stay 40 is reduced by providing the slits 44a, 44b, and 44c. This results in reduction of the vibration of the first mode to be transmitted to the light scanning apparatus 100 from the stay 40 through the supporting portions 43a, 43b, and 43c. Though this embodiment illustrates the structure in which the slits 44a, 44b, and 44c are respectively provided to all the supporting portions 43a, 43b, and 43c, the present invention is not limited to this structure. For example, only the slit 44c may be provided or only the slits 44b and 44c may be provided. In addition to the slits 44a, 44b, and 44c, one or more slits may be provided around the supporting portions 43a, 43b, and 43c.

According to the above embodiment, it is possible to reduce the vibration of the stay to be transmitted to the light scanning apparatus.

### Second Embodiment

### Structure of Stay to which Reinforcing Members Formed of Sheet Steel Are Attached

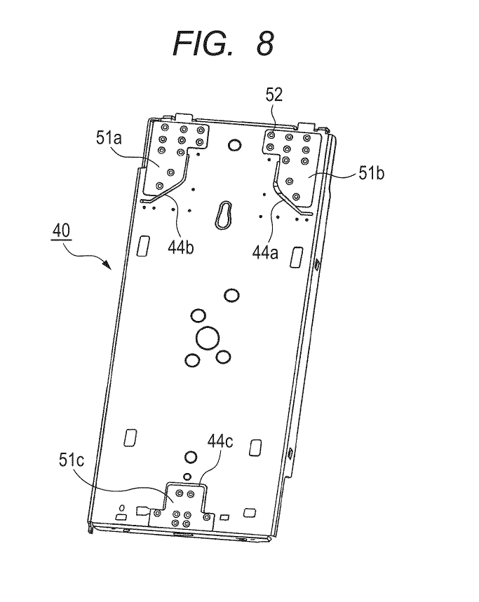

An image forming apparatus of a second embodiment is substantially the same as the structure described in the first embodiment, but is different in the structure of the stay 40. FIGS. 1 to 6B described in the first embodiment are incorporated in this embodiment. FIG. 8 illustrates the back surface of the stay 40 of FIG. 6A of this embodiment (back surface opposite to the surface of the stay 40 on which the light scanning apparatus 100 is mounted). As illustrated in FIG. 8, multiple screws 52 fix reinforcing members 51a, 51b, and 51c, each of which is formed of a steel sheet (metal sheet), at the positions of the supporting portions 43a, 43b, and 43c on the back surface of the stay 40. The reinforcing members 51a, 51b, and 51c locally increase the rigidity of the supporting portions 43a, 43b, and 43c with respect to the vibration direction of the stay 40. In this embodiment, the reinforcing members 51a, 51b, and 51c are attached by the screws 52, but the same effect can be obtained by any fixation method such as welding or adhesion. In this embodiment, a steel sheet having a thickness of 1.6 mm, for example, is used for each of the reinforcing members 51a, 51b, and 51c.

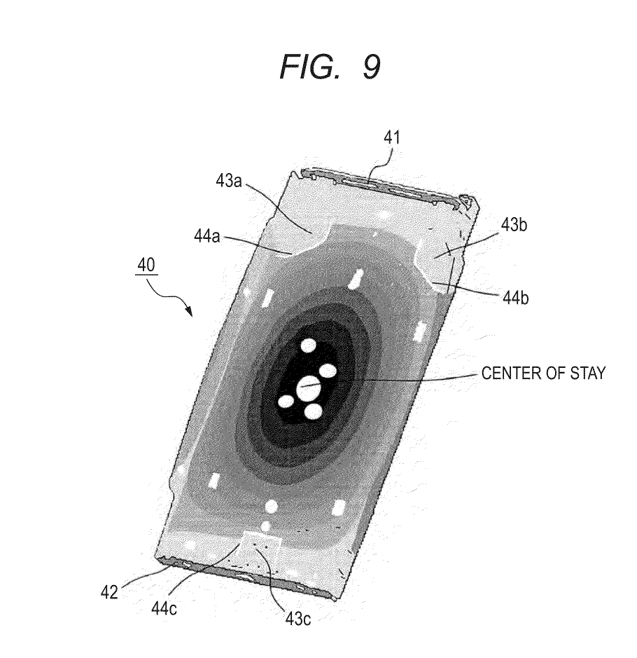

FIG. 9 illustrates an analysis result of a displacement of the stay 40 during the first mode vibration when the reinforcing members 51a, 51b, and 51c are attached to the stay 40 of FIG. 8. When the analysis result is compared with the analysis result of FIG. 7, it is apparent that the amount of displacement of each of the supporting portions 43a and 43b is reduced. This is because the attachment of the reinforcing members 51a, 51b, and 51c increases the rigidity of the supporting portions 43a, 43b, and 43c, thereby further reducing the effect by the displacement of the central portion of the stay on the supporting portions 43a, 43b, and 43c.

According to the above embodiment, it is possible to reduce the vibration of the stay to be transmitted to the light scanning apparatus.

### Third Embodiment

### Structure of Stay to which Reinforcing Members Formed of Vibration-damping Steel Sheet are Attached

An image forming apparatus of a third embodiment is substantially the same as the structure described in the first embodiment, but is different in the structure of the stay 40. FIGS. 1 to 6B described in the first embodiment are incorporated in this embodiment. The stay 40 of this embodiment has a structure in which the reinforcing members 51a, 51b, and 51c which are formed of a steel sheet as illustrated in FIG. 8 are replaced by the reinforcing members 51a, 51b, and 51c which are formed of a vibration-damping steel sheet. The vibration-damping steel sheet increases the rigidity of each of the supporting portions 43a, 43b, and 43c, as well as reduces the vibration of each of the supporting portions 43a, 43b, and 43c by the vibration damping performance of the vibration-damping steel sheet, compared with the reinforcing members 51a, 51b, and 51c which are formed only of the steel sheet of the second embodiment. The vibration-damping steel sheet has a structure in which a resin material is sandwiched between two steel sheets, for example. As in the case of steel sheet, a vibration-damping steel sheet having a thickness of 1.6 mm, for example, is used.

### Comparison of Vibration Results when Reinforcing Members are Attached

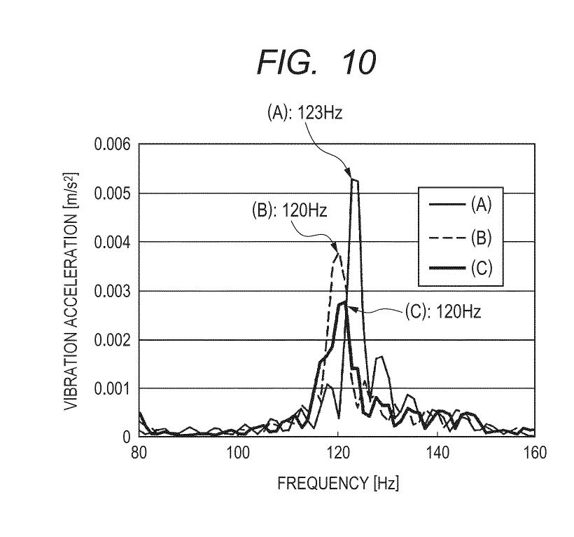

The graph of FIG. 10 illustrates a vibration acceleration at a central portion of a reflection mirror 9 when a vibration of 80 Hz to 160 Hz, including the frequency of the first mode of the stay 40 of this embodiment on which the light scanning apparatus 100 is mounted, is continuously excited (sweep excitation). The vibration is applied to the side plate 21 by an exciting device for about five minutes.

The graph of FIG. 10 illustrates vibration reduction effects of the stay 40 including the slits 44a, 44b, and 44c and the steel sheet structure of the second embodiment and of the stay 40 including the slits 44a, 44b, and 44c and the vibration-damping steel sheet structure of the third embodiment. Measurement targets are as follows. First, (A) indicated by a solid line represents the case where a stay is not provided with the slits 44a, 44b, and 44c, that is, the case where the stay 800 is used. Next, (B) indicated by a dashed line represents the case where the stay 40 of the second embodiment which is provided with the slits 44a, 44b, and 44c and the reinforcing members formed of a steel sheet is used. Further, (C) indicated by a thick solid line represents the case where the stay 40 of the third embodiment which is provided with the slits 44a, 44b, and 44c and the reinforcing members formed of a vibration-damping steel sheet is used.

In the graph of FIG. 10, the frequency in the vicinity of 120 Hz where the vibration acceleration (m/s²) on the longitudinal axis is at the peak is the natural frequency of the vibration in the first mode of the stay 40 on which the light scanning apparatus 100 is mounted. When the vibration accelerations in the vicinity of 120 Hz are compared, the vibration acceleration of the stay 40 of the case (B) which is provided with the slits 44a, 44b, and 44c and the reinforcing members formed of a steel sheet according to the second embodiment is reduced by about 30%, compared with the stay of the case (A) which is not provided with the slits 44a, 44b, and 44c. The vibration acceleration of the stay 40 of the case (C) which is provided with the slits 44a, 44b, and 44c and the reinforcing members formed of a vibration-damping steel sheet according to the third embodiment is further reduced by about 30%, compared with the stay 40 of the case (B) which is provided with the slits 44a, 44b, and 44c and the reinforcing member formed of a steel sheet according to the second embodiment. Thus, it is confirmed that the vibration of each of the supporting portions 43a, 43b, and 43c during the first mode vibration of the stay 40 is reduced by the slits 44a, 44b, and 44c and the reinforcing members 51a, 51b, and 51c formed of a steel sheet, and the vibration to be transmitted to the light scanning apparatus 100 is reduced. It is also confirmed that use of the vibration-damping steel sheet having a vibration damping performance as the reinforcing members 51a, 51b, and 51c enables effective reduction of the vibration to be transmitted to the light scanning apparatus 100, compared with the case of providing the reinforcing members 51a, 51b, and 51c formed of a steel sheet.

According to the above embodiment, it is possible to reduce the vibration of the stay to be transmitted to the light scanning apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-161087, filed Jul. 22, 2011, which is hereby incorporated by reference herein in its entirety.

1. An image forming apparatus comprising:
an image bearing member;
a latent image forming unit configured to form an electrostatic latent image on the image bearing member based on image data;
a mounting board which is attached to a main body of the image forming apparatus and onto which the latent image forming unit is mounted, the mounting board including a plurality of supporting portions to which a plurality of attaching portions included in the latent image forming unit is attached, and the mounting board including openings which have one of a bent shape or a curved shape and which are formed between the supporting portions and a central portion of the mounting board so as to surround the supporting portions; and
a reinforcing member attached to a back surface of the supporting portions to reinforce the supporting portions, the back surface being opposite to a surface on which the latent image forming unit is mounted.

2. The image forming apparatus according to claim 1, wherein each of the openings surrounding a corresponding one of the supporting portions is provided at a side closer to the corresponding supporting portion between the central portion of the mounting board and the corresponding supporting portion.

3. The image forming apparatus according to claim 1, wherein each of the openings surrounding a corresponding one of the supporting portions is formed along the attaching portion attached to the corresponding supporting portion, between the central portion of the mounting board and the corresponding supporting portion.

4. The image forming apparatus according to claim 1, wherein a direction of a protrusion of one of the bent shape and the curved shape of each of the openings surrounding the supporting portions is directed to the central portion of the mounting board.

5. The image forming apparatus according to claim 1, wherein the supporting portions and each of the openings surrounding the supporting portions are provided at an end portion of the mounting board.

6. The image forming apparatus according to claim 1, wherein one of the bent shape or the curved shape of each of the openings surrounding a corresponding one of the supporting portions has a different shape depending on a position of the corresponding supporting portion.

7. The image forming apparatus according to claim 1, wherein at least one of the openings is provided corresponding to each of the supporting portions.

8. (canceled)

9. The image forming apparatus according to claim 1, wherein the reinforcing member is attached to a position of the supporting portions on the back surface of the mounting board.

10. The image forming apparatus according to claim 1, wherein the reinforcing member is a metal sheet.

11. The image forming apparatus according to claim 1, wherein the reinforcing member is a vibration-damping steel sheet.

12. The image forming apparatus according to claim 1, wherein the image bearing member is a photosensitive member onto which the electrostatic latent image is formed,
the latent image forming unit includes a light source that outputs a light beam to expose the photosensitive member, a deflection unit that deflects the light beam to allow the light beam output from the light source to scan the photosensitive member, an optical member that guides the light beam deflected by the deflection unit to the photosensitive member, and a housing that accommodates the deflection unit and the optical member, and
the plurality of attaching portions projects from a bottom surface of the housing.
